(19) United States
(12) Patent Application Publication
(10) Pub. No.: US 2026/0067270 A1
(43) Pub. Date: Mar. 5, 2026

(54) TWO FACTOR AUTHENTICATION

(71) Applicant: Telefonaktiebolaget LM Ericsson (publ), Stockholm (SE)

(72) Inventors: Charles HEGARTY, Stockholm (SE); Håkan ÖSTERLUND, Ekerö (SE); Lu ZHOU, Guangzhou, Guangdong (CN)

(73) Assignee: Telefonaktiebolaget LM Ericsson (publ), Stockhoilm (SE)

(21) Appl. No.: 19/107,085

(22) PCT Filed: Dec. 22, 2022
(86) PCT No.: PCT/SE2022/051234

§ 371 Date: Feb. 27, 2025

(30) Foreign Application Priority Data
Aug. 30, 2022 (WO) PCT/CN2022/115827

(51) Int. Cl. H04L 9/40

(52) U.S. Cl. CPC H04L 63/083; H04L 63/10

(57) ABSTRACT

A method performed by an entitlement configuration server (106). The method includes receiving a validation request message comprising a first authorization token, authToken, and a phone number. The method also includes retrieving a second authToken, wherein the retrieving comprises using the phone number to retrieve the second authToken. The method also includes determining whether the first authToken is valid, wherein the determining comprises determining whether the first authToken is identical to the secondauthToken. The method also includes transmitting a validation response message responsive to the validation request message, wherein the validation response message indicates whether or not the first authToken is valid. Further methods, apparatus, computer programs and carriers are also disclosed.

### TECHNICAL FIELD

Disclosed methods, devices, application servers, a server, an entitlement configuration server, an exposure function, computer programs, computer program products, and a carrier related to authentication.

### BACKGROUND

Service providers (e.g., websites or application (app) providers) often use two factor authentication (“2FA”) to authenticate a user. Typically, the service provider (e.g., website) generates a random 6-8 digit “one-time-passcode” (OTP) and sends the OTP to the user's device (e.g., smartphone) via Short Message Service (SMS). When the user receives the OTP, the user inputs the OTP into an app or web page manually for authentication.

An Entitlement Configuration Server (ECS) is a node/device deployed in a Communication Service Provider (CSP) (a.k.a., Mobile Network Operator (MNO)) network to configure a device-based service (i.e., a native app built into the device operating system (OS)) during the entitlement verification step of the service or during the activation of the service. The typical device-based services include voice over Long Term Evolution (VoLTE), voice over WiFi (VoWiFi), and On-Device Service Activation (ODSA) of Companion devices (associated with a requesting device) and Primary devices, etc. Most CSPs have deployed an ECS in their network.

For the protocol between the user's device (commonly referred to as “user equipment (UE)” or “communication device”) and the ECS, more and more CSPs and device vendors are embracing the protocol specified in the Global Systems for Mobile Communications (GSM) Association (GSMA) TS.43(1), e.g. version 8.0. In this GSMA technical specification, to support different use cases, device authentication leverages on Extensible Authentication Protocol for 3^{rd} Generation Authentication and Key Agreement (EAP-AKA) according to Internet Engineering Task Force (IETF) Request for Comment (RFC) 4187 (“RFC 4187), which is an Extensible Authentication Protocol (EAP) mechanism for authentication and session key distribution, using an integrated circuit card (ICC) in the UE (e.g., a tamper-resistant ICC or an ICC having tamper resistant subscriber identity module (SIM)). IETF RFC 4187 has also been updated by IETF RFCs 5448 and 9048. The ICC in the UE may be a universal integrated circuit card (UICC) including one or more SIMs, such as a universal SIM (USIM) and/or an Internet Protocol (IP) Multimedia Services Identity Module (ISIM), other memory, or any combination thereof. The UICC may for example be an embedded UICC (eUICC), integrated UICC (iUICC), or a removable UICC commonly known as “SIM card.” Such kind of authentication is secure, providing the mutual authentication between the UE and the network.

Once the UE passes the EAP-AKA authentication against ECS, some specific apps (e.g., the native app built into the device OS) can ask for the ECS to generate a temporary token, and then this temporary token is passed to this specific service's application server to fetch the phone number (e.g., Mobile Station International Subscriber Directory Number (MSISDN)) from ECS. This use case is defined in the Change Request (CR) 1051 of the GSMA TS.43 v8.0.

### SUMMARY

Certain challenges presently exist. For instance, an assumption behind OTP via SMS for 2FA is that only the user of the UE to which the OTP is sent can receive the OTP and input it for the 2FA. But, unfortunately, this assumption is not always valid because there are sceneries in which an unauthorized user (eavesdropper or “attacker”) can obtain the OTP. For example, SMS messages sent over a GSM network can be intercepted (i.e., an attacker can sniff the OTP on the air). As another example, security vulnerabilities in a UE can make it easy for an attacker to obtain the OTP, for example, a Trojan horse placed on the UE can receive the OTP and forward it to the attacker's email. Even some normal applications (apps) with the privilege to access the UE's SMS introduces the risk for the OTP leak if it is hijacked by criminals.

Besides the security risk, some users find it cumbersome and inconvenient to have to receive an OTP and manually input the OTP each time the user wants to access a service (e.g., a website, a remote app, a resource, etc.). While some modern OSs have introduced the feature to read the OTP automatically when receiving and autofill it for the service, this additional step to input the OTP is still a bit annoying and increases the risk for leaking the OTP.

Accordingly, in one aspect there is provided a method for determining whether to allow a user to access a service (e.g., website or resource), the method utilizing a first device running a first app and a second app, wherein the first app is either a 3rd party app that the user uses to access the service or non-3rd party app (e.g., an aggregator app or CSP app) for enabling the user to access the service using a second device separate from the first device. The method includes: the second app receiving an indication that the first app has requested an authentication token; after or before receiving the indication, the second app obtaining a first authorization token, authToken, from an entitlement configuration server, ECS; and after receiving the indication, the second app providing the authToken to the first app. The step of obtaining the authToken comprises the second app performing either a first authentication process or a second authentication process. The first authentication process comprising: transmitting to an entitlement configuration server, ECS, a request message comprising an unexpired second authentication token (e.g., a fast authentication token) for enabling the ECS to determine that the second app has previously been authenticated (e.g., USIM authenticated); and receiving a response message responsive to the request message, the response message comprising the authToken. The second authentication process comprising: transmitting to the ECS a request message comprising a concealed subscription identifier (e.g., a 5G Subscription Concealed Identifier (SUCI)); after transmitting the request message, receiving a challenge message from the ECS; generating a challenge response, RES, using a key stored in an ICC in the first device (e.g., a key that is coded in a USIM stored on the ICC); transmitting a challenge response message responsive to the challenge message, the challenge response message comprising the RES; and after transmitting the challenge response message, receiving a response message responsive to the request message, the response message comprising the authToken and an indication that the second app has been successfully authenticated.

In another aspect there is provided a method for determining whether a device a user is using to gain access to a service is an authorized device (e.g., a device comprising a USIM tied to a phone number registered to the service by a subscriber of the service), the service being provided by a service provider associated with an application server, the method being performed by a first app running on the device. The method includes: the first app obtaining an authorization token, authToken, from a second app running on the device; the first app sending to the application server an authentication request message comprising the authToken, the authentication request message further comprising an identifier associated with the user and/or a phone number, and the first app receiving from the application server an authentication response message responsive to the authentication request message, wherein the authentication response message indicates whether or not the device is an authorized device.

In another aspect there is provided a method for determining whether a device a user is using to gain access to a service is an authorized device, the service being provided by a service provider associated with an application server, the method being performed by the application server. The method includes: receiving from a first app running on the device an authentication request message comprising an authToken the first app obtained from a second app running on the device; after receiving the authentication request message, providing the authToken and a phone number to an ECS; receiving an indication indicating that the ECS has determined that the authToken is linked to the provided phone number; and after receiving the indication indicating that the ECS has determined that the authToken is linked to the provided phone number, transmitting to the first app an authentication response message responsive to the authentication request message, wherein the authentication response message indicates that the device is an authorized device.

In another aspect there is provided a method for determining whether to allow a user of a first device to access a service, the method being performed by a first app running on a second device. The Method includes: the first app receiving a first authentication request message, the first authentication request message comprising a phone number and a message for a user of the second device; after receiving the first authentication request: the first app displaying the message to the user of the second device and, after displaying the message, the first app receiving an indication indicating whether or not the user of the second device approves of allowing the user of the first device to access the service; and if indication indicates that the user of the second device approves of allowing the user of the first device to access the service, the first app sending to a remote server (e.g., aggregator AF or ECS) a second authentication request message comprising: an authentication token, authToken, obtained from a second app running on the second device and the phone number.

In another aspect there is provided a method for determining whether to allow a user of a first device to access a service, the method being performed by an application server associated with the service. The method includes: the application server receiving from the first device a message comprising information indicating that the user of the first device would like to gain access to the service; after receiving the message from the first device, the application server transmitting to a second server (e.g., AF of aggregator or ECS) an authentication request message comprising a phone number; and after transmitting the authentication request message, the application server receiving an authentication response message responsive to the authentication request message, wherein the authentication response message indicates that a user of a second device associated with the phone number has authorized the user of the first device to access the service.

In another aspect there is provided a method for determining whether to allow a user of a first device to access a service, the method being performed by a remote server (AF of aggregator or ECS) remote from the first device. The method includes: the remote server receiving from an application server associated with the service a first message comprising a phone number; after receiving the first message, the remote server transmitting a second message to a first app running on a second device associated with the phone number, the second message comprising the phone number; after transmitting the second message to the first app, receiving from the first app a third message comprising an authentication token and the phone number; in response to receiving the third message, determining whether or not the authorization token is valid; and if it is determined that the authorization token is valid, the remote server transmitting to the application server a response message responsive to the first message, wherein the response message indicates that the second device is an authorized device and a user of the second device does not object to the user of the first device accessing the service.

In another aspect there is provided a method performed by an entitlement configuration server, ECS. The method includes: receiving a validation request message comprising a first authorization token, authToken, and a phone number; retrieving a second authToken, wherein the retrieving comprises using the phone number to retrieve the second authToken; determining whether the first authToken is valid, wherein the determining comprises determining whether the first authToken is identical to the second authToken; and transmitting a validation response message responsive to the validation request message, wherein the validation response message indicates whether or not the first authToken is valid.

In another aspect there is provided a computer program comprising instructions which when executed by processing circuitry of an apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided a computer program product which comprises a computer readable storage medium on which the computer program is stored. In another aspect there is provided an apparatus that is configured to perform the methods disclosed herein. The apparatus may include memory and processing circuitry coupled to the memory.

An advantage of the embodiments disclosed herein is that they provide a 2FA procedure that provides more security than the traditional SMS-OTP 2FA. Additionally, there is no need to provide any OTP to the user, which make the 2FA procedure more user-friendly.

### BRIEF DESCRIPTION OF THE DRAWINGS

The accompanying drawings, which are incorporated herein and form part of the specification, illustrate various embodiments.

FIG. 1 illustrates a system according to an embodiment.

FIG. 2 illustrates a system according to an embodiment.

FIG. 3 illustrates a system according to an embodiment.

FIG. 4 is a message flow diagram illustrating an embodiment.

FIG. 5 is a message flow diagram illustrating an embodiment.

FIG. 6 is a message flow diagram illustrating an authentication procedure according to an embodiment for authenticating a native app.

FIG. 7 is a flowchart illustrating a process according to an embodiment.

FIG. 8 is a flowchart illustrating a process according to an embodiment.

FIG. 9 is a flowchart illustrating a process according to an embodiment.

FIG. 10 is a flowchart illustrating a process according to an embodiment.

FIG. 11 is a flowchart illustrating a process according to an embodiment.

FIG. 12 is a flowchart illustrating a process according to an embodiment.

FIG. 13 is a flowchart illustrating a process according to an embodiment.

FIG. 14 is a block diagram of a UE according to an embodiment.

FIG. 15 is a block diagram of a base station according to an embodiment.

FIG. 16 is a message flow diagram illustrating an embodiment.

### DETAILED DESCRIPTION

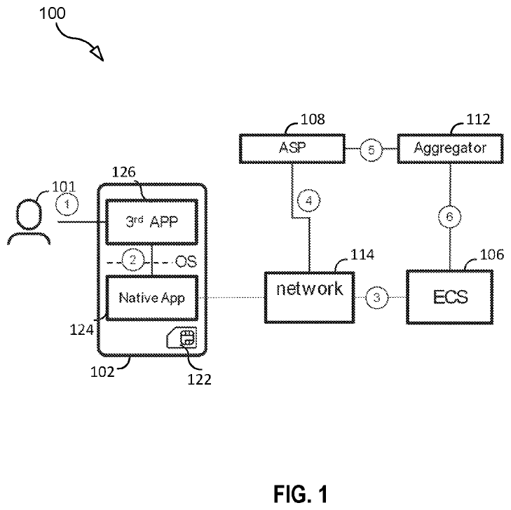

FIG. 1 illustrates a system 100 according to an embodiment. In the embodiment shown, system 100 includes: a UE 102 (UE 102 can by any type device capable of communication with a remote server); a network 114; an ECS 106 (while ECS 106 is shown as being separate from network 114, in some embodiments ECS 106 is within network 114, e.g., within a core network of network 114); an application server platform (ASP) 108 (e.g., a set of one or more application servers); and an aggregator 112. Network 114 may be any type of network (e.g., network 114 may include one of or any combination of: a wireless local area network (WLAN) (e.g., a WLAN based on an IEEE 802.11 standard (a.k.a., WiFi)), a non-wireless network, a 3GPP radio access network (RAN), a 3GPP core network (CN)). As further shown, UE 102 includes an ICC 122 (e.g., a UICC described in the background); a native app 124, which in this example is part of the OS of UE 102; and a 3rd party app 126 that runs on top of the OS of UE 102.

This disclosure leverages ICC based authentication capability of native app 124 and an authentication token (a.k.a., “token” for short or “authToken”) generated by ECS 106 to support the internet service (App or Web based) provided by ASP 108 to perform the 2FA authentication in a “silent” mode (i.e., a mode in which the user 101 need not input an OTP). With this new authentication method, security is enhanced. Moreover, the user experience is improved because the user 101 is not aware of the 2FA process occurring.

In one embodiment, for user 101 to gain access to the service provided by ASP 108, the user provides the user's credentials (e.g., username and password) to ASP 108, via app 126, in the conventional manner. That is, app 126 may prompt user to enter the user's credentials and then forwards the credentials to ASP 108 so that ASP 108 can verify the credentials. If the credentials are verified, ASP 108 then sends a message to app 126. In one embodiment, the message triggers that app 126 to prompt the user to enter the phone number of UE 102 (step (1)). In another embodiment, the message triggers app 126 to request app 124 to provide an authentication token (or “token” for short) (step (2)). For example, app 126 may make use of an OS application programming interface (API) to request the token.

App 124 then sends to ECS 106, via network 114, a request message requesting that ECS 106 generate a token (step (3)). ECS 106 generates the token, stores the token in association with a phone number associated with app 124 (e.g., the request message from app 124 includes information (e.g., a SUCI) that enables ECS to obtain the phone number associated with app 124), and then provides the generated token to app 124.

After app 124 obtains the token from ECS 106, app 124 provides the token to app 126. App 126 then sends the token to ASP 108 (step (4)).

ASP 108 sends to aggregator 112 a message comprising the token and a phone number associated with the account that user 101 is trying to access (step (5)). Aggregator 112, based on the phone number selects an ECS (which in this case is ECS 106) and then sends to ECS 106 a validation request message comprising the token and phone number (step (6)).

ECS then verifies the received token. That is, for example, ECS 106 uses the phone number included in the validation request to retrieve a previously generated token, if any, associated with the telephone number. If no such previously generated token exists, then the received token is not valid. If such previously generated token does exist, ECS determines whether or not the previously generated token has expired (e.g., based on a time value stored in association with the previously generated token which time value indicates an expiration time for the token). If such previously generated token does exist and has not expired, ECS determines whether the received token is identical to the previously generated token. If yes, then the received token is valid, otherwise it is invalid.

If the received token is determined to be valid, ECS 106 sends to aggregator 112 a positive acknowledgment (ACK) to indicate that the token is valid, otherwise a negative ACK (NACK) is sent to indicate invalid token. The aggregator 112 sends the ACK or NACK to ASP 108 to indicate whether the token is valid. When ASP 108 obtains the ACK, ASP 108 determines that user 101 has been successfully authenticated (i.e., ASP 108 determines that device 102 is an authorized device—i.e., the phone number the user input when the user registered for the service is tied to device 102). In this way, ASP provides 2FA that is transparent to user 101.

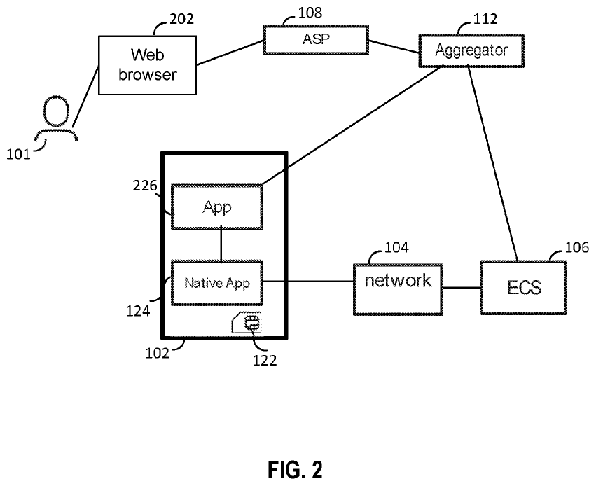

FIG. 2 illustrates a system 200 according to another embodiment. System 200 is like system 100 except that user 101 uses the service provided by ASP 108 using another device 202 (e.g., laptop computer, desktop computer, tablet, etc.). In the embodiment shown, user 101 uses a web browser running on device 202 to access the service.

In this embodiment, user 101 downloads and installs on UE 102 an authenticator app 226. Then, user 101 uses device 202 to access the desired service. For example, using device 202, user 101 visits a webpage provided by ASP 108 and enters the user's credential in the conventional manner.

After the user's credentials are verified by ASP 108, ASP 108 initiates the second phase of the 2FA. That is, in this example, ASP 108 sends an authentication request to aggregator 112. This request includes a phone number associated with the user's credentials (e.g., stored in a user profile associated with the user's user id). For example, when the user signed up for the service provided by ASP 108, the user was required to provide a cell phone number. The request may also include a user consent message (e.g., “Are you using a web browser on a device located in Falls Church VA to access the service? Yes or No?”).

In response to receiving the request from ASP 108, aggregator 112 sends a message to app 226. This message to app 226 includes the phone number and the user consent message.

In response to receiving the message from aggregator 112, app 226 displays the user consent message to a user of device 202 (which may be user 101 or another user (e.g. user 101's spouse)) and waits for a user input. If the user input indicates that the user of device does not object to allowing user 101 to access the service (e.g., the user selected the “Yes” option), then app 226 triggers app 124 to obtain a token and provide the token to app 226. For example, app 226 may make use of an OS application programming interface (API) to request the token from app 124.

App 124 then sends to ECS 106, via network 114, a request message requesting that ECS 106 generate a token. ECS 106 generates the token, stores the token in association with a phone number associated with app 124 (e.g., the request message from app 124 includes information (e.g., a SUCI) that enables ECS to obtain the phone number associated with app 124), and then provides the generated token to app 124.

After app 124 obtains the token from ECS 106, app 124 provides the token to app 226. App 226 then sends the token to aggregator 112 along with the phone number that App 226 receive in the request from the aggregator 112.

Aggregator 112, based on the phone number selects an ECS (which in this case is ECS 106) and then sends to ECS 106 a validation request comprising the token and phone number. ECS then verifies the received token as described above with respect to the embodiment shown in FIG. 1.

If the received token is determined to be valid, ECS 106 sends to aggregator 112 a positive acknowledgment (ACK) to indicate that the token is valid, otherwise a negative ACK (NACK) is sent to indicate invalid token. The aggregator 112 sends the ACK or NACK to ASP 108 to indicate whether the token is valid. When ASP 108 obtains the ACK, ASP 108 determines that user 101 has been successfully authenticated (i.e., ASP 108 determines that a user of device 102 does not object to user 101 accessing the service). In this way, ASP provides 2FA that is transparent to user 101.

### Additional Details

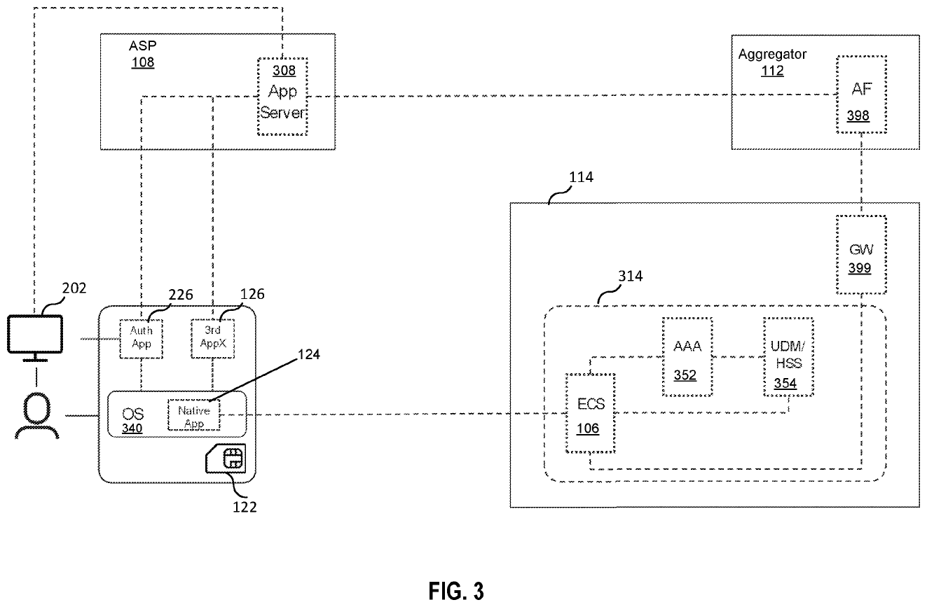

FIG. 3 shows additional details of a system according to some embodiments.

As shown in FIG. 3, Native app 124 (a.k.a., “entitlement client”) resides in the OS 340 of UE 102 and performs an authentication against ECS 106 periodically or on demand (e.g., triggered by Auth App 226 or 3^{rd} party App 126) utilizing the ICC 122 of the UE, wherein stored on the ICC is a subscription identifier (SUI) (e.g., a Subscription Permanent Identifier (SUPI), which, in some embodiment may be an International Subscriber Identity (IMSI)) allocated by a CSP to a subscriber of the CSP. If the authentication passes, ECS 106 generates an “authentication token” (a.k.a, “authToken”) tied to the SUI (e.g., associated with a phone number associated with the SUI) and also generates a “fast authentication token” and returns the tokens to app 124. In some embodiments, the fast authentication token is generated in accordance with RFC 4187.

Because the authentication using ICC 122 performed between app 124 and ECS 106 is a mature mutual authentication algorithm without any user intervention and the CSP that allocated the SUI maintains in its core network an association between the SUI (e.g., IMSI) stored in ICC 122 and the phone number tied to the SUI, the ECS generated token (authToken) is linked to the phone number in a secure way, which can be used by the 3^{rd} party app 126 or the dedicated auth app 226 to validate an authentication token.

Whenever the App 126 or the App 226 needs to perform the phone number validation as the 2FA for the service, the app 126/226 can fetch the token from the API exposed by the OS. To enhance the security and support having multiple simultaneous authentication sessions, the App 126/226 can also give an OTP to app 124, where the OTP functions as an authentication session identifier.

Once the app 126/226 gets the auth token from the OS, together with the optional OTP when requesting the auth token, the app 126/226 triggers a request to a server (e.g., server 308 of ASP 108, AF 398 of aggregator 112, or ECS 106) for validation.

In one embodiment, if AS 308 gets the validation request, it contacts an application function (AF) 398 of aggregator 112 which routes the request to the correct ECS for validation, which in this case is ECS 106. AF 398 determines the address of the correct ECS (e.g. IP address or domain name of the ECS) based on the phone number. That is, using the phone number, AF 398 determines the CSP to which the phone number belongs and then, based on stored configuration information for the determined CSP, finds the address of the ECS belonging to the determined CSP. After the AF 398 identifies the ECS, the eventual validation request is invoked via a gateway 399 (e.g., Service Capability Exposure Function (SCEF) or Network Exposure Function (NEF)) as per 3GPP Technical Specification (TS) 29.522 V 17.6.0 (“TS 29.522”).

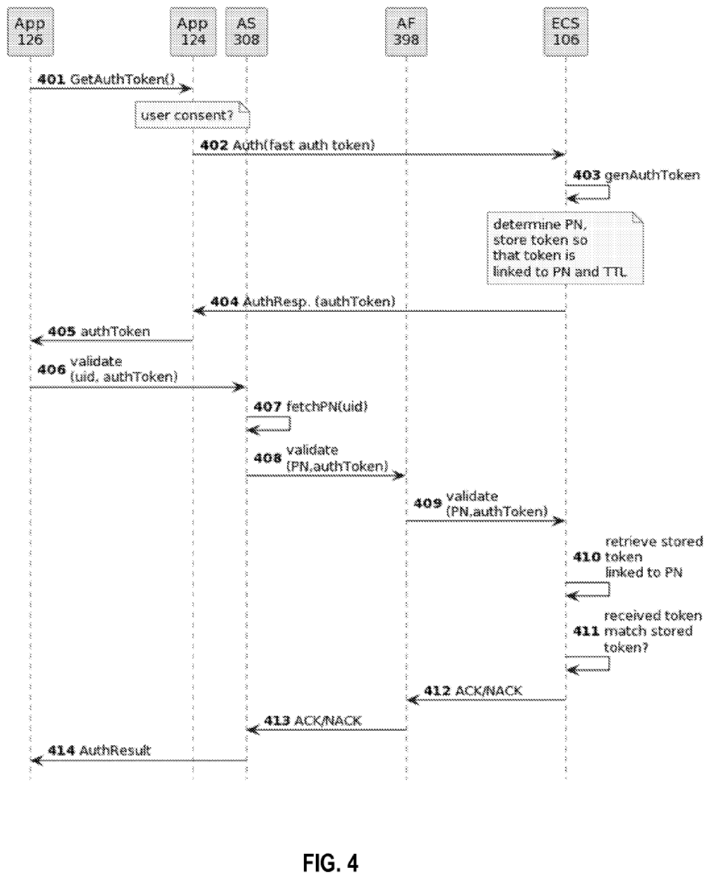

FIG. 4 is a message flow diagram illustrating a message flow according to one embodiment.

401: App 126 begins the second phase of the 2FA process by requesting an authToken from app 124. For example, in one embodiment, when user 101 opens app 126, app 126 may authenticate user 101 (e.g., user facial recognition or fingerprint or username/pwd, etc.) and after app 126 has authenticated the user, app 126 may begin the second phase of 2FA.

Optionally, an OTP can be introduced. Accordingly, in some embodiments, app 126 obtain an OTP and provides the OTP to app 124 when requesting the authToken.

402: App 124 performs the ICC based authentication against the ECS 106. In this example, app 124 performs an ICC based fast authentication (which means that app 124 has previously performed an ICC based full authentication). As is known in the art, after app 124 performs the full authentication procedure, app 124 obtains from ECS a fast authentication token (e.g., a fast authentication token according fast re-authentication mechanism/method of RFC 4187), which enables app 124 to subsequently perform fast re-authentications until the fast auth token expires.

More specifically, in this step app 124 transmits to ECS 106 an authentication request message comprising a fast auth token that app 124 previously obtained from ECS after performing a full authentication with the ECS (also, if OTP was provided in step 401, then OTP is included in the authentication request message). In addition to including the fast auth token (and OTP, if any), the authentication request message also includes a concealed subscriber identifier (CSUI) (e.g., a 5G Subscription Concealed Identifier (SUCI) which is an encrypted version of the SUPI). If the fast auth token is not presented, invalid, or expired, the ECS needs to perform the full based authentication based the credential stored on the ICC 122 and in the CSP core network. The authentication algorithm can be but not limited to EAP-SIM, EAP-AKA, 5G-AKA, EAP-AKA′, EAP-TLS (EAP-Transport Layer Security) etc.

In some embodiments, prior to app 124 performing the ICC based authentication in response to the trigger from app 126 (or after but before providing the authToken to app 126), app 124 displays on a display of device 102 a user consent message and waits for a user input. The user consent message may say, e.g., “Someone is attempting to use this device to access ‘[Service Name]’.” Is this you? Yes or No?. If this answer is no, the process ends otherwise app 124 will proceed. In this embodiment, when app 126 triggers app 124 to get the token, app 126 may provide to app 124 a string containing the Service Name.

403: ECS generates an authToken and links the authToken to a phone number (PN) (e.g., MSISDN) (and also linked to OTP, if OTP is included), where the PN is determined from information included in the authentication request message. For example, using a SUCI included in the authentication request message, the ECS can obtain an IMSI from the SUCI (e.g., decrypt the SUCI) and then use the IMSI to obtain subscription information associated with the IMSI, which subscription information includes a phone number (hence the phone number is tied to the IMSI). A time-to-live value (TTL) is also assigned to the authToken (the TTL indicates a time at which the authToken expires) and stored with the authToken and phone number (and OTP, if present). For example, after generating the authToken, ECS links the authToken to the PN and TTL (and OTP, if present) by, for example, storing in a database a record having a key field containing the PN or IMSI, a token filed storing authToken, a TTL field storing the TTL value, and an OTP field if needed to store the OTP, if any. In some embodiments, the authToken is simply a random number or string generated by ECS. If OTP is included, the OTP may be used to generate the random number.

In some embodiments, the authentication request message is transported from app 124 to ECS 106 in one or more IP protocol data units (PDUs) (a.k.a., IP packets). In such embodiments, ECS may extract the source IP address from one of the IP packets and links the authToken to the extracted IP address. For example, ECS 106 may store in a database a record having a key field containing the PN or IMSI, a token filed storing authToken, a TTL field storing the TTL value, an IP address field storing the extracted IP address, and an OTP field if needed to store the OTP, if any.

404: ECS returns the ICC based authentication result (e.g., fast authentication token) and the authToken.

405: App 124 returns the authToken to the App 126.

406: App 126 sends to AS 308 a token validation request message comprising the authToken and the user's user ID (uid) (and also the OTP if present). In some embodiments, the validation request message is transported from app 126 to AS 308 in one or more IP packets. In such embodiments, AS 306 may extract the source IP address from one of the IP packets.

407: AS uses the user ID to obtain a phone number associated with the user ID. For example, whenever a user creates an account so that the user can use the service, the user provides for the account a phone number of a device having an ICC storing a SUI (e.g., IMSI) to which the phone number is tied (e.g., a database of a CSP ties the phone number to an IMSI stored on the ICC), and this phone number is stored in the user's profile, which can be access by knowing the user's user ID.

408: In the example shown, an aggregator is used, which means that AS 308 does not communicate directly with ECS 106, but rather communicates indirectly with ECS 106 via AF 398. Accordingly, in this embodiment, AS 308 transmits to AF 398 a validation request that comprises the authToken and the phone number obtained in step 407 (and also the OTP, if OTP is being used to increase security). In some embodiments, the validation request sent by AS 308 also includes the IP address extracted by AS 308 from an IP packet that was used to transport the validation request message transmitted by App 126.

If an aggregator was not being used, then AS 308 would simply send the validation request to ECS 106.

409: AF 398 routes the validation request to the correct CSP's ECS for validation based on the phone number (or based on the phone number and the IP address included in the validation request transmitted by AS 308). The validation request is sent via the GW 399 for most of the CSP's deployment.

410 and 411: After receiving the validation request, ECS determines, based on the PN included in the validation request (and also the OTP if OTP is being used and/or IP address if an IP address is included in the validation request), whether the authToken included in the validation request is valid. That is, for example, as described previously, ECS 106 uses the phone number included in the validation request (or phone number and OTP, if OTP is included) to retrieve a previously generated authToken, if any, associated with the telephone number and OTP, if included. If no such previously generated authToken exists, then the received authToken is not valid. If such previously generated authToken does exist, ECS determines whether or not the previously generated authToken has expired (e.g., based on the TTL stored in association with the previously generated authToken). In embodiments in which the authToken is linked with an IP address, ECS 106 determines whether or not the IP address linked with the authToken matches the IP address included in the validation request, if any. If such previously generated authToken exists and has not expired and the IP addresses match, ECS determines whether the received authToken is identical to the previously generated authToken. If yes, then the received authToken is valid, otherwise it is invalid.

412: If the authToken is valid, ECS 106 transmits to AF 398 an ACK (i.e., a message indication that ECS 106 has determined the authToken to be valid), otherwise, ECS 106 transmits to AF 398 a NACK.

413: AF 398 forwards the ACK/NACK to AS 308. If an aggregator is not used, then ECS 106 would transmits the ACK/NACK to AS 308. If an ACK is received, this indicates to AS that the device the user is using to access the service is an “authorized device.” That is, the device has an ICC to which the phone number obtained in step 407 is tied (i.e., the ICC stores a SUI (e.g., SUPI) to which the phone number is tied.

414. AS 308 transmits an authorization result message to app 126, indicating whether or not user 101 is authorized.

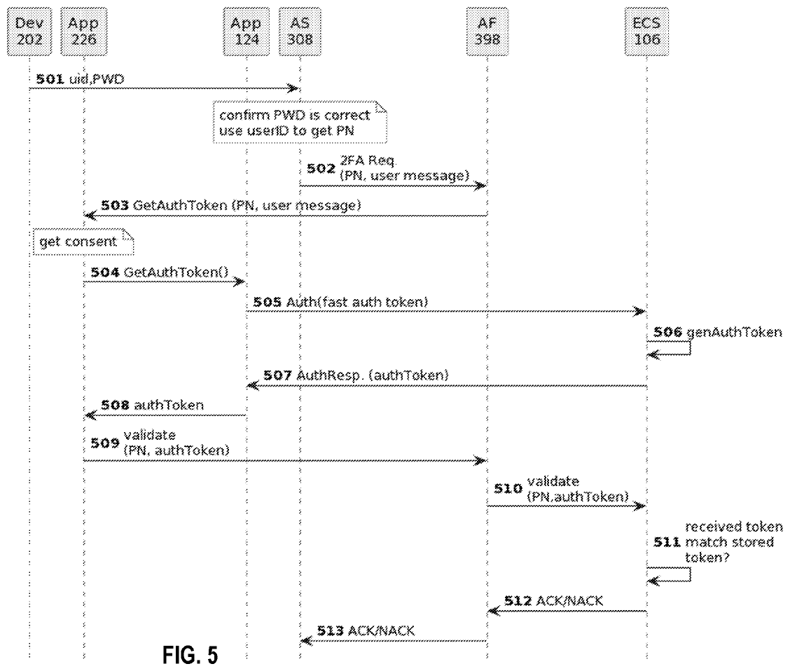

FIG. 5 is a message flow diagram illustrating a message flow according to an embodiment in which the user accesses the service provided by ASP 108 via device 202.

501: The device 202 sends to the AS 308 a message to indicate the CSP phone number-based authentication is required. The message includes a user id (e.g., a user id that user 101 input into device 101 to gain access to the service). The Application Server then determines a phone number based on the user id.

502: In the case the aggregator is deployed, as in the example shown, the Application Server contacts the Application Function (AF) of the aggregator, providing a message comprising the phone number and a user consent message, to ask for the silent authentication. If the aggregator is not used, then the AS, based on the phone number, selects an ECS sends the message to the selected ECS.

503: The AF notifies the app 226, which may be owned by the aggregator, to kick of the silent authentication process, providing to app 226 a “getAuthToken” message containing the phone number and user consent message. In the case that no aggregator is used deployed, this message is sent to app 226 by the ECS 106. The app 226 is woken up by the getAuthToken message and displays the user consent message to a user of device 102 (which may be user 101 or another user (e.g. user 101's spouse)) and waits for a user input.

504: If the user input indicates that the user of device does not object to allowing user 101 to access the service (e.g., the user selected the “Yes” option), then app 226 triggers app 124 to obtain an authToken and provide the authToken to app 226. For example, app 226 may make use of an OS API to request the authToken from app 124. In this step, as noted above, app 226 may provide an OTP to app 124.

505: App 124 performs the ICC based authentication against the ECS 106. In this example, app 124 performs a fast authentication. More specifically, in this step app 124 transmits to ECS 106 an authentication request message comprising a fast auth token that app 124 previously obtained from ECS after performing a full authentication with the ECS (also, if OTP was provided, then OTP is included in the authentication request message). In addition to including the fast auth token (and OTP, if any), the authentication request message also includes a concealed subscriber identifier (e.g., 5G Subscription Concealed Identifier). As noted above, if the fast auth token is not presented, invalid, or expired, the ECS needs to perform the full authentication based the credential stored on the ICC 122 and in the CSP core network, the authentication algorithm can be but not limited to EAP-SIM, EAP-AKA, 5G-AKA, EAP-AKA′ etc.

506: ECS generates an authToken that is then linked to a phone number (PN) (e.g., MSISDN) (and also linked to OTP, if OTP is included) determined from information included in the authentication request message. A TTL is also assigned to the authToken and stored with the authToken and phone number. Also, as noted above with respect to step 403 of FIG. 4, in some embodiments, ECS may extract the source IP address from one of the IP packets used to transport the authentication request message and links the authToken with the extracted IP address.

507: ECS returns the ICC based authentication result and the authToken.

508: App 124 returns the authToken to the App 226.

509: App 226 sends to AF 398 an authToken validation request message comprising the authToken and phone number received from AF 398 (and also the OTP if present). If the aggregator is not being used, then this validation request message would be transmitted by app 226 to ECS 106, thereby bypassing the aggregator 112.

510: AF 398 routes the validation request to the correct CSP's ECS for validation based on the phone number. The request is sent via the GW 399 for most of the CSP's deployment. In some embodiments, the validation request message is transported from app 226 to AF 398 in one or more IP packets. In such embodiments, AS 306 may extract the source IP address from one of the IP packets and add the extracted IP address to the validation request message that is sent by AF 398 to the ECS.

511: After receiving the validation request, the ECS determines whether the authToken included in the validation request is valid. That is, the ECS performs steps 410 and 411 described above.

512: If authToken is valid, ECS 106 transmits to AF 398 an ACK, otherwise, ECS 106 transmits to AF 398 a NACK.

513: AF 398 forwards the ACK/NACK to AS 308. If an aggregator is not used, then ECS 106 would transmits the ACK/NACK to AS 308. If an ACK is received, this indicates to AS that the device on which app 226 is running is an “authorized device.” That is, as an example, the device has a USIM to which the phone number obtained in step 501 is tied.

AS 308 may then transmit an authorization result message to device 202, indicating whether or not user 101 has been authenticated.

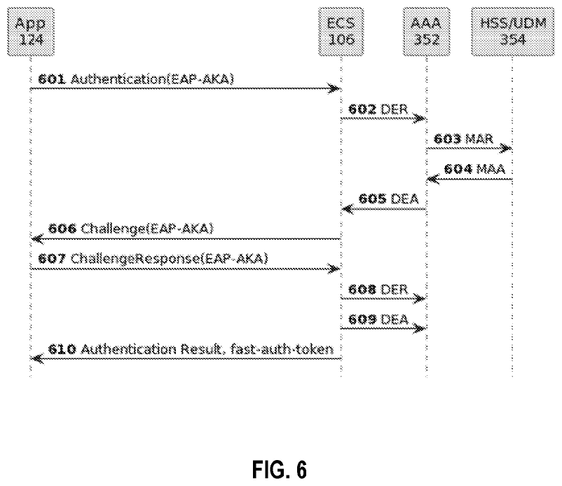

As explained above, if app 124 does not have a valid fast authentication token, then the full authentication procedure needs to be performed. FIG. 6 is a message flow illustrating an ICC based full authentication procedure according to an embodiment. More specifically, FIG. 6 illustrates EAP-AKA authentication process for illustrative purposes only, and is not limiting.

601: App 124 triggers the EAP-AKA authentication (i.e., sends authentication request message comprising an IMSI stored in ICC 122.

602: The ECS sends a diameter-based DER request to AAA to start the EAP-AKA authentication.

603: The AAA sends a diameter-based MAR request to HSS/UDM to retrieve the authentication vector based on the IMSI of the UE 102 (IMSI is obtained from the SUCI).

604: HSS/UDM returns the authentication credential to AAA in the diameter-based MAA response for EAP-AKA authentication.

605: AAA generates an EAP-AKA challenge payload to and return it in the diameter-based DEA response to ECS.

606: ECS returns the EAP-AKA challenge to app 124.

607: App 124 contacts an app on ICC 122 (e.g., a USIM) to validate the challenge from the network, calculate the EAP-AKA challenge response for validation and sends it back to ECS.

608: ECS forwards the EAP-AKA challenge response from app 124 to AAA via another diameter-based DER request.

609: AAA validates the EAP-AKA challenge response to determine the authentication is successful or failed and return the result to ECS.

610: ECS generates a fast auth token for the next authentication and ECS also generates the authToken for the silent 2FA and return the results to app 124.

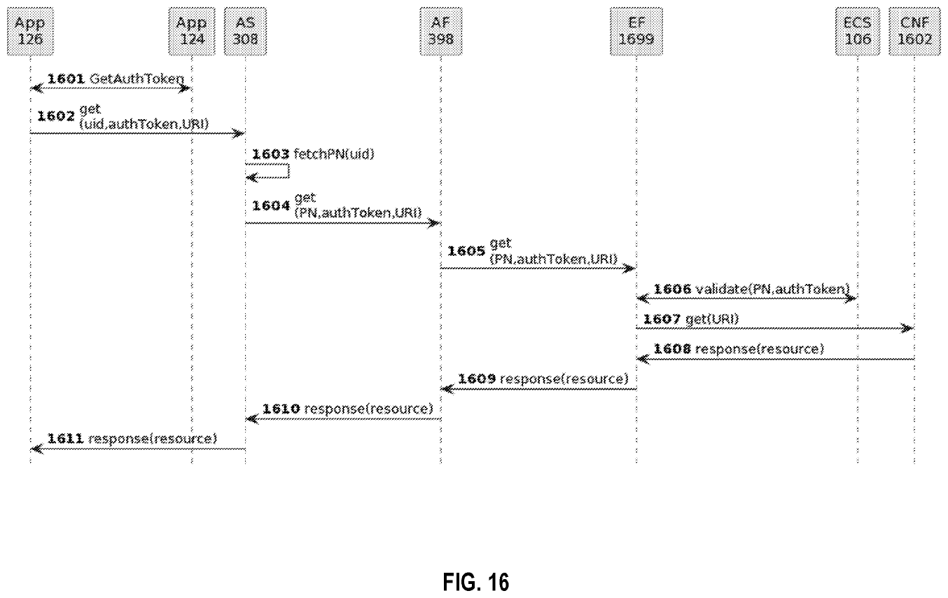

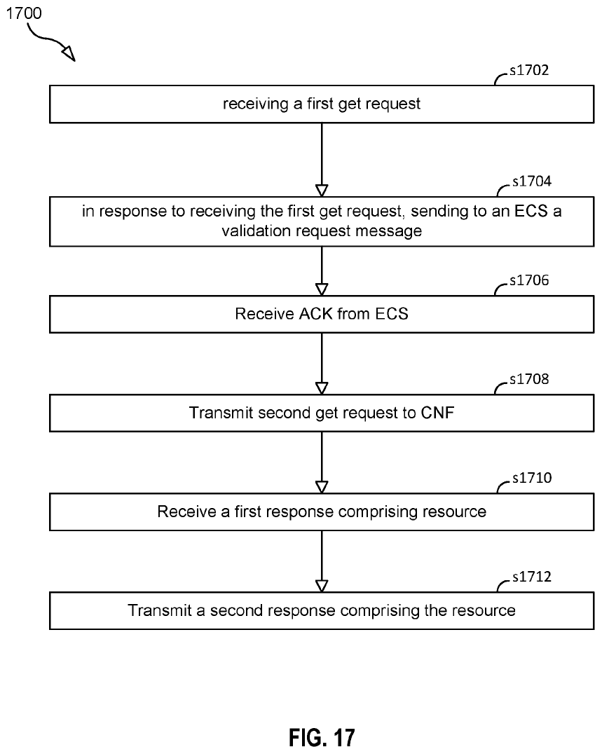

FIG. 16 is a message flow diagram illustrating an embodiment in which App 126 uses the authToken to obtain a resource. For example, if App 126 possesses a valid authToken, then App 126 will be authorized to obtain the resource. In the example shown below, App 126 obtain a resource from a core network function (CNF) 1602 via an exposure function (EF) 1699 (e.g., a 3GPP Network Exposure Function (NEF) or a Service Capability Exposure Function (SCEF)). The message flow may begin with step 1601.

1601: App 126 obtains an authToken using the process described above. That is, step 1601 encompasses steps 401-405.

1602: After obtaining the authToken, App 126 uses the authToken to attempt to obtain a resource from CF. For example, in step 1602, App 126 transmits to AS 308 a get request message comprising the user's user ID (uid), the authToken, and a resource identifier (e.g., a Uniform Resource Identifier) that identifies the desired resource.

1603: AS uses the user ID to obtain a phone number associated with the user ID. This step corresponds to step 407.

1604: In the example shown, an aggregator is used, which means that AS 308 does not communicate directly with EF 1699, but rather communicates indirectly with EF 1699 via AF 398. Accordingly, in this embodiment, AS 308 transmits to AF 398 a get request that comprises the authToken, the phone number obtained in step 1603, and the resource identifier (and also the OTP, if OTP is being used to increase security). In some embodiments, the get request sent by AS 308 also includes a source IP address (i.e., the IP address of the device on which App 126 is running) extracted by AS 308 from an IP packet that was used to transport the get request message transmitted by App 126.

1605: AF 398 routes the get request to the correct CSP's EF based on the phone number (or based on the phone number and the IP address included in the validation request transmitted by AS 308). The get request is sent via the GW 399 for most of the CSP's deployment.

1606: EF 1699 then sends to ECS 106 a validation request message containing the authToken and phone number. After receiving the validation request, the ECS determines whether the authToken included in the validation request is valid. That is, the ECS performs steps 410 and 411 described above. If authToken is valid, ECS 106 transmits to EF 1699 an ACK, otherwise, ECS 106 transmits to EF 1699 a NACK.

1607: If EF 1699 receives an ACK from the ECS, then EF 1699 transmits to CNF 1602 a get request message comprising the resource identifier, otherwise EF 1699 would sends a NACK to AF 398, which would then send NACK to AS 308.

1608: In response to receiving the get request message transmitted by EF 1699, CNF 1602 uses the resource identifier to obtain a resource (e.g., CNF may use the resource identifier to retrieve a resource (e.g., file) from a file system or invoke a process that generates the resource) and then, after obtaining the resource, CNF 1602 transmits to EF 1699 a response message comprising the resource.

1609: EF 1699 then transmits to AF 398 a response message comprising the resource.

1610: AF 398 forwards the response message to AS 308. In embodiments where an AF is not used, AS 308 would receive the response message transmitted by EF 1699.

1611: AS 308 forwards the response message comprising the resource to App 126. In this manner, App 126 uses the authToken to obtain a resource from a core network function within a mobile network operator's core network.

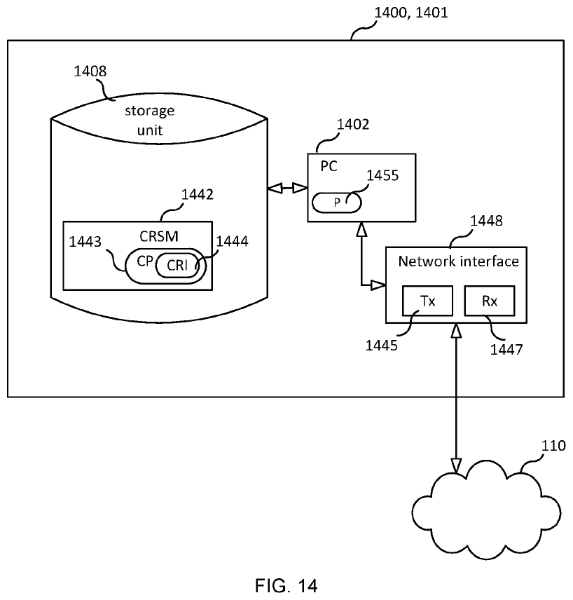

FIG. 14 is a block diagram of apparatus 1400, according to some embodiments. Apparatus 1400 can be used to implement any one of the servers (e.g., the application server, the ECS, the remote server, etc.) disclosed herein and any one of the functions disclosed herein (e.g., the EF, the AF, the CNF, etc.). When apparatus 1400 implements EF 1699, apparatus 1400 may be referred to as an EF apparatus 1401. As shown in FIG. 14, apparatus 1400 may comprise: processing circuitry (PC) 1402, which may include one or more processors (P) 1455 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 1400 may be a distributed computing apparatus); at least one network interface 1448 (e.g., a physical interface or air interface) comprising a transmitter (Tx) 1445 and a receiver (Rx) 1447 for enabling apparatus 1400 to transmit data to and receive data from other nodes connected to a network 110 (e.g., an Internet Protocol (IP) network) to which network interface 1448 is connected (physically or wirelessly) (e.g., network interface 1448 may be coupled to an antenna arrangement comprising one or more antennas for enabling apparatus 1400 to wirelessly transmit/receive data); and a storage unit (a.k.a., “data storage system”) 1408, which may include one or more non-volatile storage devices and/or one or more volatile storage devices. In embodiments where PC 1402 includes a programmable processor, a computer readable storage medium (CRSM) 1442 may be provided. CRSM 1442 may store a computer program (CP) 1443 comprising computer readable instructions (CRI) 1444. CRSM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes apparatus 1400 to perform steps described herein (e.g., steps described herein with reference to the flow charts). In other embodiments, apparatus 1400 may be configured to perform steps described herein without the need for code. That is, for example, PC 1402 may consist merely of one or more ASICs. Hence, the features of the embodiments described herein may be implemented in hardware and/or software.

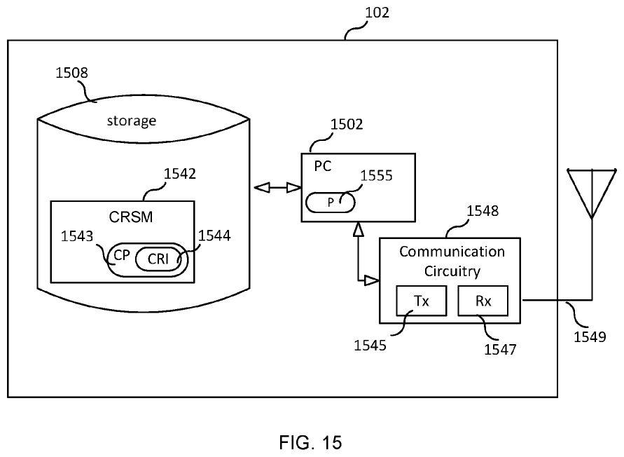

FIG. 15 is a block diagram of UE 102, according to some embodiments. As shown in FIG. 15, UE 102 may comprise: processing circuitry (PC) 1502, which may include one or more processors (P) 1555 (e.g., one or more general purpose microprocessors and/or one or more other processors, such as an application specific integrated circuit (ASIC), field-programmable gate arrays (FPGAs), and the like); communication circuitry 1548, which is coupled to an antenna arrangement 1549 comprising one or more antennas and which comprises a transmitter (Tx) 1545 and a receiver (Rx) 1547 for enabling UE 102 to transmit data and receive data (e.g., wirelessly transmit/receive data); and a storage unit (a.k.a., “data storage system”) 1508, which may include one or more non-volatile storage devices and/or one or more volatile storage devices. In embodiments where PC 1502 includes a programmable processor, a computer readable storage medium (CRSM) 1542 may be provided. CRSM 1542 may store a computer program (CP) 1543 comprising computer readable instructions (CRI) 1544. CRSM 1542 may be a non-transitory computer readable medium, such as, magnetic media (e.g., a hard disk), optical media, memory devices (e.g., random access memory, flash memory), and the like. In some embodiments, the CRI 1544 of computer program 1543 is configured such that when executed by PC 1502, the CRI causes UE 102 to perform steps described herein (e.g., steps described herein with reference to the flow charts). In other embodiments, UE 102 may be configured to perform steps described herein without the need for code. That is, for example, PC 1502 may consist merely of one or more ASICs. Hence, the features of the embodiments described herein may be implemented in hardware and/or software.

### Summary of Various Embodiments

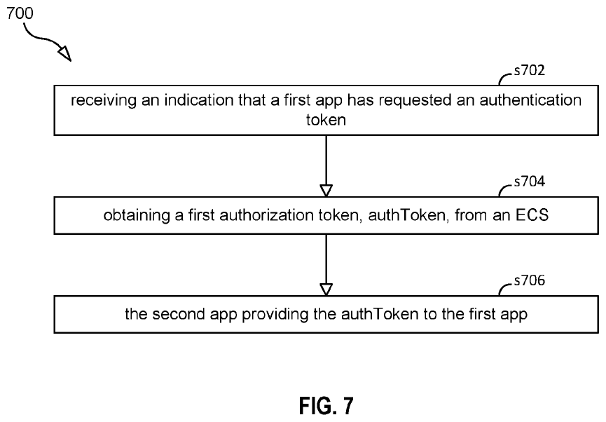

A1. A method 700 (see FIG. 7) for determining whether to allow a user to access a service, the method utilizing a first device (e.g., UE 102) running a first app and a second app, wherein the first app is either a 3rd party app that the user uses to access the service or non-3rd party app (e.g., an aggregator app or CSP app) for enabling the user to access the service using a second device separate from the first device. The method includes: the second app receiving an indication that the first app has requested an authentication token (step s702); after or before receiving the indication, the second app obtaining a first authorization token, authToken, from an entitlement configuration server, ECS (step s704); and after receiving the indication, the second app providing the authToken to the first app (step s706). The step of obtaining the authToken comprises the second app performing either a first authentication process or a second authentication process. The first authentication process comprising: transmitting to an entitlement configuration server, ECS, a request message comprising an unexpired second authentication token (e.g., a fast authentication token, e.g. according to fast re-authentication as included in EAP-AKA mechanism) for enabling the ECS to determine that the second app has previously been authenticated using a Universal Subscriber Identity Module (USIM) (e.g. according to EAP-AKA, 5G AKA, EAP-TLS or EAP-AKA′); and receiving a response message responsive to the request message, the response message comprising the authToken. The second authentication process comprising: transmitting to the ECS a request message comprising a concealed subscription identifier (e.g., a 5G Subscription Concealed Identifier (SUCI)); after transmitting the request message, receiving a challenge message from the ECS; generating a challenge response, RES, using a key stored in an ICC or a tamper-resistant identity module (e.g., a USIM of a UICC) in the first device; transmitting a challenge response message responsive to the challenge message, the challenge response message comprising the RES; and after transmitting the challenge response message, receiving a response message responsive to the request message, the response message comprising the authToken and an indication that the second app has been successfully authenticated.

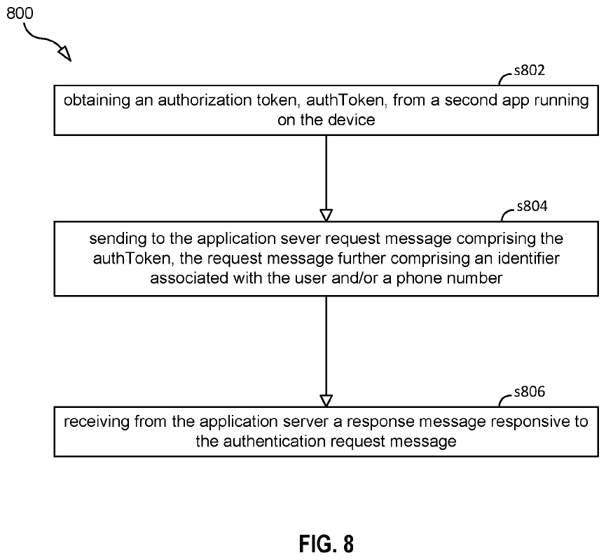

B1. A method 800 (see FIG. 8) for determining whether a device a user is using to gain access to a service is an authorized device (e.g., a device comprising a USIM or SIM profile tied to a phone number registered to the service by a subscriber of the service), the service being provided by a service provider associated with an application server, the method being performed by a first app running on the device. Method 800 includes: the first app obtaining an authorization token, authToken, from a second app running on the device (step s802); the first app sending to the application server a request message comprising the authToken, the authentication request message further comprising an identifier associated with the user and/or a phone number (step s804) (the request message may be a get request message that also includes a resource identifier); and the first app receiving from the application server a response message responsive to the request message, wherein the response message indicates whether or not the device is an authorized device, or the response message comprises a resource that was requested by the first app (126) (step s806).

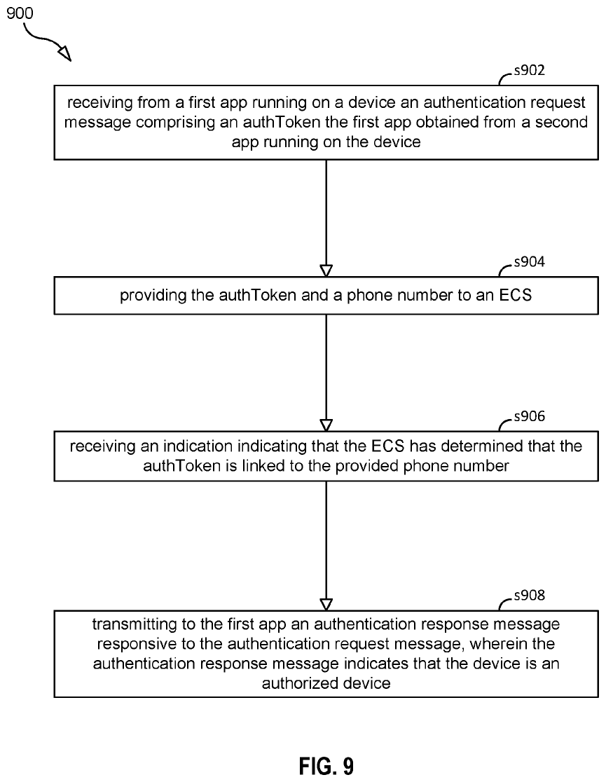

C1. A method 900 (see FIG. 9) for determining whether a device a user is using to gain access to a service is an authorized device, the service being provided by a service provider associated with an application server, the method being performed by the application server. Method 900 includes: receiving from a first app running on the device an authentication request message comprising an authToken the first app obtained from a second app running on the device (step s902); after receiving the authentication request message, providing the authToken and a phone number to an ECS (step s904); receiving an indication indicating that the ECS has determined that the authToken is linked to the provided phone number (step s906); and after receiving the indication indicating that the ECS has determined that the authToken is linked to the provided phone number, transmitting to the first app an authentication response message responsive to the authentication request message, wherein the authentication response message indicates that the device is an authorized device (step s908).

C2. In some embodiments, wherein providing the authToken and phone number to the ECS comprises: transmitting to the ECS a message comprising the authToken and phone number or transmitting to an application function of an aggregator a first message comprising the authToken and phone number, wherein the AF is configured to send to the ECS a second message comprising the authToken and phone number.

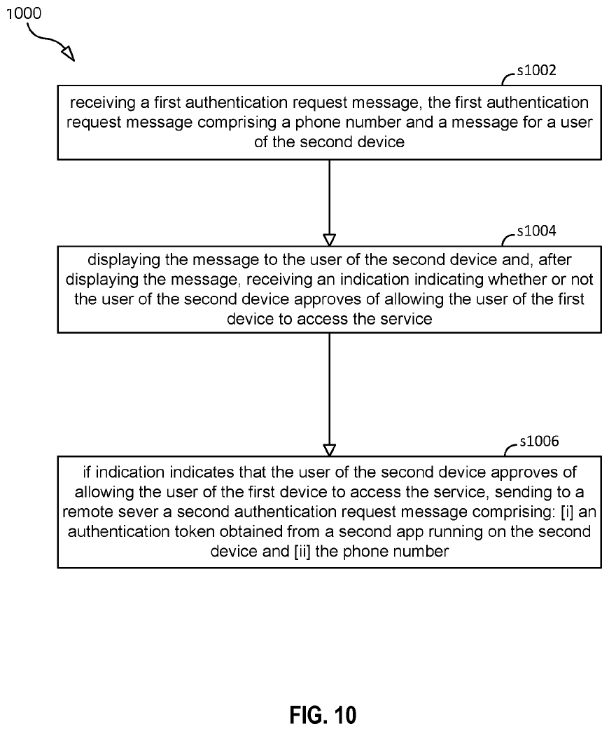

D1. A method 1000 (see FIG. 10) for determining whether to allow a user of a first device to access a service, the method being performed by a second device. Method 1000 includes: receiving a first authentication request message, the first authentication request message comprising a phone number and a message for a user of the second device (step s1002); after receiving the first authentication request: displaying the message to the user of the second device and, after displaying the message, receiving an indication indicating whether or not the user of the second device approves of allowing the user of the first device to access the service (step s1004); and if indication indicates that the user of the second device approves of allowing the user of the first device to access the service, sending to a remote server (e.g., aggregator AF or ECS) a second authentication request message comprising: an authentication token, authToken, and the phone number (step s1006).

D2. In some embodiments, the user of the first device and the user of the second device is the same person.

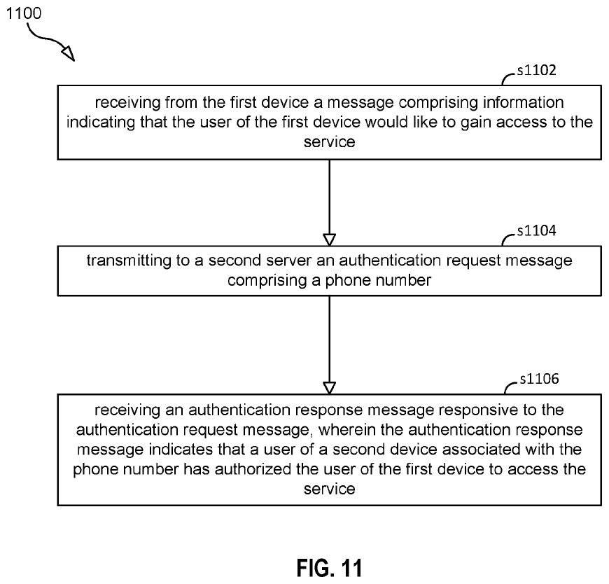

E1. A method 1100 (see FIG. 11) for determining whether to allow a user of a first device to access a service, the method being performed by an application server associated with the service. Method 1100 includes: the application server receiving from the first device a message comprising information indicating that the user of the first device would like to gain access to the service (step s1102); after receiving the message from the first device, the application server transmitting to a second server (e.g., AF of aggregator or ECS) an authentication request message comprising a phone number (step s1104); and after transmitting the authentication request message, the application server receiving an authentication response message responsive to the authentication request message, wherein the authentication response message indicates that a user of a second device associated with the phone number has authorized the user of the first device to access the service (step s1106).

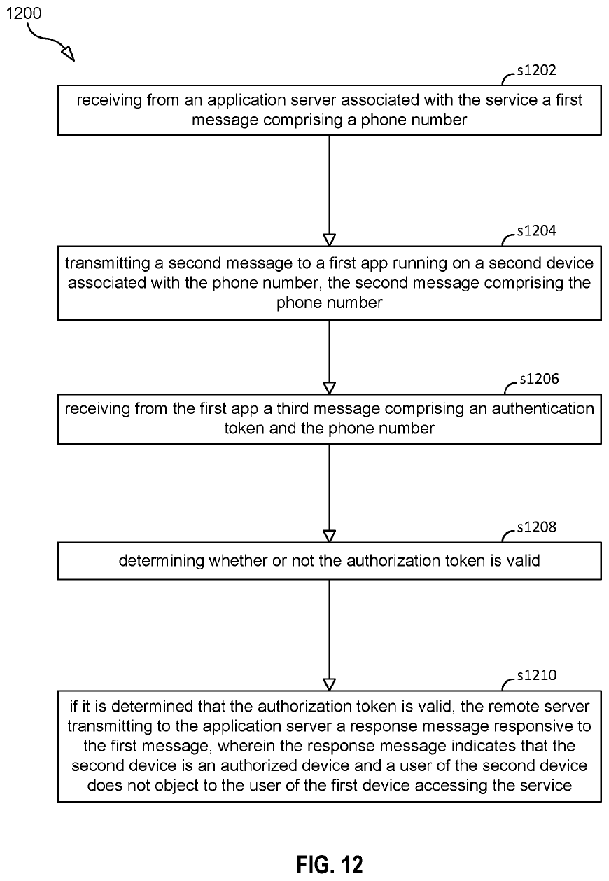

F1. A method 1200 (see FIG. 12) for determining whether to allow a user of a first device to access a service, the method being performed by a remote server (AF of aggregator or ECS) remote from the first device. Method 1200 includes: the remote server receiving from an application server associated with the service a first message comprising a phone number (step s1202); after receiving the first message, the remote server transmitting a second message to a first app running on a second device associated with the phone number, the second message comprising the phone number (step s1204); after transmitting the second message to the first app, receiving from the first app a third message comprising an authentication token and the phone number (step s1206); in response to receiving the third message, determining whether or not the authorization token is valid (step s1208); and if it is determined that the authorization token is valid, the remote server transmitting to the application server a response message responsive to the first message, wherein the response message indicates that the second device is an authorized device and a user of the second device does not object to the user of the first device accessing the service (step s1210).

F2. In some embodiments, determining whether or not the authorization token is valid comprises: transmitting to an ECS a validation message comprising the authorization token and the phone number; and receiving from the ECS a response to the validation message, wherein the response indicator whether or not the authentication token is valid.

F3. In some embodiments, determining whether or not the authorization token is valid comprises: using the phone number to retrieve a previously generated token; and comparing the previously generated token with the authentication token.

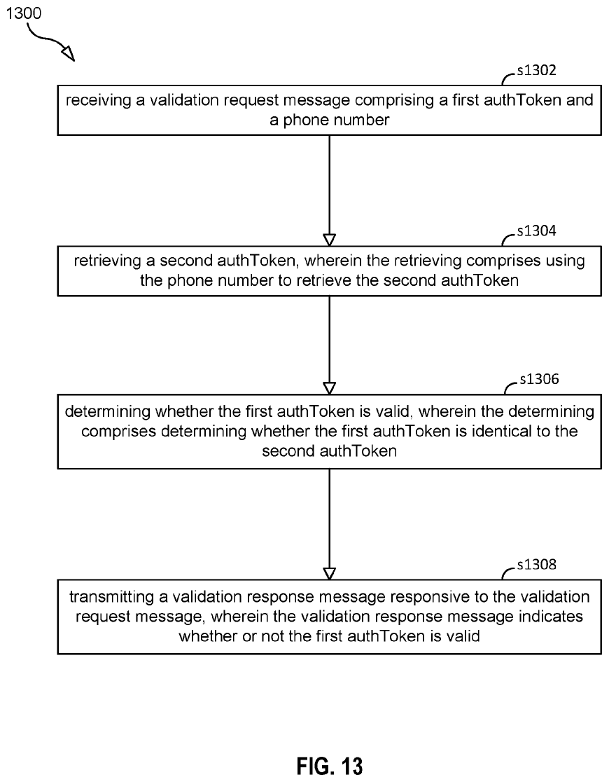

G1. A method 1300 (see FIG. 13) performed by an entitlement configuration server, ECS. The method includes: receiving a validation request message comprising a first authorization token, authToken, and a phone number (step s1302); retrieving a second authToken, wherein the retrieving comprises using the phone number to retrieve the second authToken (step s1304); determining whether the first authToken is valid, wherein the determining comprises determining whether the first authToken is identical to the second authToken (step s1306); and transmitting a validation response message responsive to the validation request message, wherein the validation response message indicates whether or not the first authToken is valid (step s1308).

G2. In some embodiments, the validation request message further comprises a code (e.g., a one-time-pass code), and retrieving the second authToken comprises using the phone number and the code to retrieve the second authToken.

G3. In some embodiments the method also includes prior to receiving the validation request message, generating the second authToken; and storing the second authToken so that the second authToken is associated with the phone number.

G4. In some embodiments, the second authToken is stored so that the second authToken is associated with both the phone number and the code.

G5. In some embodiments, determining whether the first authToken is valid further comprises: determining whether the second authToken has expired; determining whether the second authToken has been revoked, and/or determining a subscription identifier associated with the second authToken is associated to the phone number.

G6. In some embodiments the method also includes, after determining whether the first authToken is valid, revoking the second authToken (e.g., deleting it from an authToken database).

H1. A computer program (1443) comprising instructions (1444) which when executed by processing circuitry (1402) of an apparatus causes the apparatus to perform the method of any one of embodiments C1, C2, E1, F1-F3, or G1-G6.

H2. A computer program (1543) comprising instructions (1544) which when executed by processing circuitry (1502) of a UE causes the UE to perform the method of any one of claims A1, B1, D1, or D2.

H3. A carrier containing the computer program of claim H1 or H2, wherein the carrier is one of an electronic signal, an optical signal, a radio signal, and a computer readable storage medium (1442, 1542).

I1. A method 1700 (see FIG. 17) performed by EF 1699. The method includes receiving a first get request message comprising a resource identifier, a phone number, and an authToken (step s1702). The method also includes, in response to receiving the first get request message, sending to the ECS, a validation request message comprising the authToken and the phone number (step s1704). The method also includes receiving from the ECS an acknowledgment message indicating that the authToken is valid (step s1706). The method also includes, in response to receiving acknowledgment message, transmitting the CNF 1602, a second get request message comprising the resource identifier (step s1708). The method also includes, after transmitting the second get request message, receiving from the CNF a first response message responsive to the second get request message, the response message comprising a resource the CNF obtained using the resource identifier (step s1710). The method also includes, after receiving the first response message, transmitting a second response message responsive to the first get request message, the second response message comprising the resource (step s1712).

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1-7. (canceled)

8. A method for determining whether to allow a user of a first device to access a service, the method being performed by a remote server remote from the first device, and the method comprising:
the remote server receiving from an application server associated with the service a first message comprising a phone number;
after receiving the first message, the remote server transmitting a second message to a first app running on a second device associated with the phone number, the second message comprising the phone number;
after transmitting the second message to the first app, receiving from the first app a third message comprising an authentication token and the phone number;
in response to receiving the third message, determining whether or not the authorization token is valid; and
if it is determined that the authorization token is valid, the remote server transmitting to the application server a response message responsive to the first message, wherein the response message indicates that the second device is an authorized device and a user of the second device does not object to the user of the first device accessing the service.

9. The method of claim 8, wherein determining whether or not the authorization token is valid comprises:
transmitting to an entitlement configuration server (ECS) a validation message comprising the authorization token and the phone number; and
receiving from the ECS a response to the validation message, wherein the response indicator whether or not the authentication token is valid.

10. The method of claim 8, wherein determining whether or not the authorization token is valid comprises:
using the phone number to retrieve a previously generated token; and
comparing the previously generated token with the authentication token.

11. A method performed by an entitlement configuration server (ECS), the method comprising:
receiving a validation request message comprising a first authorization token, authToken, and a phone number;
retrieving a second authToken, wherein the retrieving comprises using the phone number to retrieve the second authToken;
determining whether the first authToken is valid, wherein the determining comprises determining whether the first authToken is identical to the second authToken; and
transmitting a validation response message responsive to the validation request message, wherein the validation response message indicates whether or not the first authToken is valid.

12. The method of claim 11, wherein
the validation request message further comprises a code, and
retrieving the second authToken comprises using the phone number and the code to retrieve the second authToken.

13. The method of claim 12, further comprising:
prior to receiving the validation request message, generating the second authToken; and
storing the second authToken so that the second authToken is associated with the phone number.

14. The method of claim 13, wherein
the second authToken is stored so that the second authToken is associated with both the phone number and the code.

15. The method of claim 11, wherein determining whether the first authToken is valid further comprises:
determining whether the second authToken has expired;
determining whether the second authToken has been revoked; and/or
determining an subscription identifier associated with the second authToken is associated to the phone number.

16. The method of claim 11, further comprising, after determining whether the first authToken is valid, revoking the second authToken.

17-25. (canceled)

26. A server for determining whether to allow a user of a first device to access a service, the server being configured to:
receive from an application server associated with the service a first message comprising a phone number;
after receiving the first message, transmit a second message to a first app running on a second device associated with the phone number, the second message comprising the phone number;
after transmitting the second message to the first app, receive from the first app a third message comprising an authentication token and the phone number;
in response to receiving the third message, determine whether or not the authorization token is valid; and
if it is determined that the authorization token is valid, transmit to the application server a response message responsive to the first message, wherein the response message indicates that the second device is an authorized device and a user of the second device does not object to the user of the first device accessing the service.

27. The server of claim 26, wherein determining whether or not the authorization token is valid comprises:
transmitting to an entitlement configuration server (ECS) a validation message comprising the authorization token and the phone number; and
receiving from the ECS a response to the validation message, wherein the response indicator whether or not the authentication token is valid.

28. The server of claim 26, wherein determining whether or not the authorization token is valid comprises:
using the phone number to retrieve a previously generated token; and
comparing the previously generated token with the authentication token.

29-36. (canceled)

37. The method of claim 11, further comprising:
prior to receiving the validation request message, generating the second authToken; and
storing the second authToken so that the second authToken is associated with the phone number.
